(19) United States
(12) Patent Application Publication
(10) Pub. No.: US 2010/0229088 A1
(43) Pub. Date: Sep. 9, 2010

(54) GRAPHICAL REPRESENTATIONS OF MUSIC USING VARYING LEVELS OF DETAIL

(75) Inventors: Taido Nakajima, Cupertino, CA (US); Pareet Rahul, Markham (CA); Gloria Lin, San Ramon, CA (US)

Correspondence Address: KRAMER LEVIN NAFTALIS & FRANKEL LLP, 1177 Avenue of the Americas, New York, NY, 10036, US

(73) Assignee: Apple Inc., Cupertino, CA (US)

(21) Appl. No.: 12/398,056

(22) Filed: Mar. 4, 2009

(51) Int. Cl. G06F 3/01; G06F 3/048; G06F 7/06; G06F 17/30

(52) U.S. Cl. 715/702; 715/787; 715/854; 707/E17.014

(57) ABSTRACT

Systems, methods, and machine-readable media are disclosed for providing graphical representations of music of varying levels of detail. An electronic device can determine the attributes of a first type (e.g., genre) associated with the music. The electronic device can display a graphical representation of the music using the attributes. The graphical representation can be based on a spiral, helix, map, or any other geometric shape or curve. A user can zoom into a portion of the graphical representation to select the music of a particular genre in which to view more detailed information. In response, the electronic device can determine the attributes of a second, more detailed type (e.g., artist) associated with the selected music and can revise the graphical representation to use the attributes of the second type. The revised graphical representation can include album cover art associated with the selected music.

### FIELD OF THE INVENTION

This is directed to an application for presenting graphical representations of music.

### BACKGROUND OF THE DISCLOSURE

Today's electronic devices, such as desktop computers and portable music players, have large storage capabilities. Users can therefore maintain large collections of music on their electronic devices. Because a user might enjoy multiple styles of music, these large collections often contain songs with a variety of different attributes (e.g., different genres and from different eras).

Current electronic devices, however, are limited in their ability to present song options and menus to the user. One approach used by current electronic devices is to provide a textual, list-based menu that allows users to view all songs stored on the electronic device, or to view songs by an attribute, such as by genre or artist.

### SUMMARY OF THE DISCLOSURE

Accordingly, systems, methods, and machine-readable media are disclosed that can provide a graphical representation of music, such as the music stored on an electronic device (e.g., portable media player). As used herein, a “graphical representation” of elements generally refers to a display that does not present textual information about the elements in a list structure—that is, where the text for each successive element is listed below the previous elements.

In some embodiments, the electronic device can initially provide a graphical representation of music elements (e.g., songs or albums) using a first, lowest level of detail. The electronic device can determine various attributes associated with the music elements, such as the genres (e.g., hip-hop, rap, pop) associated with the music elements, and can display a graphical representation of the music elements at the first level of detail using these attributes.

For example, in some embodiments, the electronic device can display a curve-based representation of the music elements, such as a spiral or helical representation. A spiral representation can include a spiral, and the different attributes (e.g., different genres) can be presented along the spiral. This way, the music elements can be represented by their respective genres, and the user can scroll through all of the genres by, for example, providing a circular user input to rotate the spiral. In a helical representation, the graphical representation can include a helix, and the different attributes (e.g., genres) can be presented along the helix. In still other embodiments, the graphical representation can include a map of real-life geographic regions (e.g., states within the United States), where each region represents the music elements of a particular attribute.

A user can “zoom into” a portion of the graphical representation to request more detailed information about a portion of the music elements. In some embodiments, the user can use a “pinch in” motion on a multi-touch touch screen to request more detailed information about the music of a particular attribute (e.g., hip-hop music). Responsive to the request, the electronic device can revise the graphical representation to provide a second, greater level of detail for at least the music elements associated with the zoomed-in attribute, such as hip-hop music. In some embodiments, the revised graphical representation can represent the musical elements using a different set of attributes that correspond to a different attribute type.

For clarity in describing the various disclosed embodiments, an “attribute type” will hereinafter refer to a way to categorize music (e.g., genre, artist, album), and an “attribute” will hereinafter refer to one of the categories of an attribute type (e.g., hip-hop, R&B, Madonna). Thus, in some embodiments, in response to a user request to view more detailed information about music elements, the electronic device can revise the graphical representation of the music elements (displayed using a first attribute type) to present the music elements using a second attribute type. To accomplish this, the electronic device can determine, for the music elements associated with the zoomed-in attribute (e.g., hip-hop music), attributes of a second attribute type (e.g., artists) and can revise the graphical representation using the attributes of the second attribute type.

For example, responsive to a user request to view more detailed information about the music of a particular genre from a spiral representation, the electronic device can display different artists of the particular genre along the spiral. Responsive to a user request to view more detailed information from a helical representation, the electronic device can display different artists along the helix. Responsive to a user request to view more detailed information from a map-based representation, the electronic device can provide a display that appears to be a zoomed-in portion of the map, which includes regions associated with different artists.

The electronic device can continue to enable the user to view more and more detailed information about the music elements until a last level of detail is reached. In some embodiments, the electronic device can provide the music elements using three levels of detail: first by genre, then by artist, then by albums. Because multiple artists can be in the same genre, and multiple albums can be released by the same artist, this series of levels can provide increasingly specific, and therefore more detailed, information on the music elements (e.g., songs). In some embodiments, the graphical representation of the music elements at the last level of detail (or any intermediate level of detail) can include a variety of album cover art, such as a grid of album cover art.

### BRIEF DESCRIPTION OF THE DRAWINGS

The above and other aspects and advantages of the present invention will be apparent upon consideration of the following detailed description, taken in conjunction with accompanying drawings, in which like reference characters refer to like parts throughout, and in which:

FIG. 1 is a schematic view of an electronic device configured in accordance with an embodiment of the invention;

FIGS. 2-4 are illustrative display screens showing music displayed at varying levels of detail using a spiral representation in accordance with various embodiments of the invention;

FIG. 5 is an illustrative display screen showing music displayed at a first level of detail using a helical representation in accordance with an embodiment of the invention;

FIG. 6 is an illustrative display screen showing music displayed at a first level of detail using a map representation in accordance with an embodiment of the invention; and

FIG. 7 is a flowchart of an illustrative process for providing graphical representations of music at varying levels of detail.

### DETAILED DESCRIPTION

Systems, methods, and machine-readable media are disclosed for providing graphical representations of music at varying levels of detail.

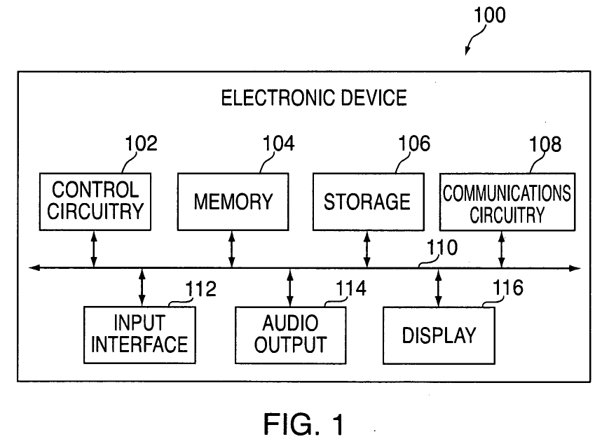

FIG. 1 is a schematic view of illustrative electronic device 100. In some embodiments, electronic device 100 can be or include a portable media player (e.g., an iPod), a cellular telephone (e.g., an iPhone), pocket-sized personal computers, a personal digital assistance (PDA), a desktop computer, a laptop computer, and any other device capable of communicating with a server or other device via wires or wirelessly (with or without the aid of a wireless enabling accessory device).

Electronic device 100 can include control circuitry 102, memory 104, storage 106, communications circuitry 108, bus 110, input interface 112, audio output 114, and display 116. Electronic device 100 can include other components not shown in FIG. 1, such as a power supply for providing power to the components of electronic device. Also, while only one of each component is illustrated, electronic device 100 can include more than one of some or all of the components.

Control circuitry 102 can control the operation and various functions of device 100. For example, control circuitry 102 can identify songs to display to a user, and can direct display 116 to display representations of the identified songs. As described in detail below, control circuitry 102 can control the components of electronic device 100 to present graphical representations of music at varying levels of detail. Control circuitry 102 can include any components, circuitry, or logic operative to drive the functionality of electronic device 100. For example, control circuitry 102 can include one or more processors acting under the control of an application.

In some embodiments, the application can be stored in memory 104 or storage 106. Memory 104 and storage 106 can include cache memory, Flash memory, read only memory (ROM), random access memory (RAM), a hard drive, Flash, or other EPROM or EEPROM or any other suitable type of memory. In some embodiments, one or both of memory 104 and storage 106 can be dedicated specifically to storing firmware for control circuitry 102. Instead or in addition, memory 104 or storage 106 can be used by electronic device 100 to store music, such as a collection of songs, and other media and electronic files (e.g., text-based files, pictures or graphics), information or metadata associated with the media, such as user-generated or automatically-created playlists, genre(s), artist(s), album(s), album cover art, release date, date of purchase or download, BPM, lyrics, vocals information, bass line information, or any other suitable information for each stored song. In some embodiments, the media and associated information can be obtained from a server, such as a file server, media server, database server, or web server. Memory 104 and storage 106 can also store any other suitable information, such as preference information (e.g., music playback preferences), lifestyle information, exercise information (e.g., obtained from exercise monitoring system), transaction information (e.g., credit card information), subscription information (e.g., for podcasts or television shows), and telephone information (e.g., an address book).

Bus 110 may provide a data transfer path for transferring data to, from, or between control circuitry 102, memory 104, storage 106, communications circuitry 108, and some or all of the other components of electronic device 100.

Communications circuitry 108 can enable electronic device 100 to communicate with other devices, such as to a server (e.g., file server, media server, database server, or web server). For example, communications circuitry 108 can include Wi-Fi enabling circuitry that permits wireless communication according to one of the 802.11 standards or a private network. Other wired or wireless protocol standards, such as Bluetooth, can be used in addition or instead.

Input interface 112, audio output 114, and display 116 can provide a user interface for a user to interact with electronic device 100. Input interface 112 may enable a user to provide inputs and feedback to electronic device 100. Input interface 112 can take any of a variety of forms, such as one or more of a button, keypad (e.g., computer keyboard), dial, click wheel, touch screen (e.g., a multi-touch touch screen), or accelerometer. Audio output 114 provides an interface by which electronic device 100 can provide music and other audio elements to a user. Audio output 114 can include any type of speaker, such as computer speakers or headphones. Display 116 can present visual media (e.g., graphics such as album cover, text, and video) to the user. Display 116 can include, for example, a liquid crystal display (LCD), a touch screen display, or any other type of display.

In some embodiments, electronic device 100 can provide graphical representations of music. As described above, a “graphical representation” of elements generally refers to a display that does not present textual information about the elements in a list structure—that is, where the text for each successive element is listed below the previous elements. Also, “music” or “music elements” can refer to an audio unit of any suitable type, such as a song or album of songs. While the embodiments of this disclosure are generally described to provide graphical representations of music, it should be understood that the features can be used to provide graphical representations of any other type of media or file, such as videos or pictures.

Electronic device 100 can display graphical representations of music at a variety of levels of detail. In some embodiments, each successive level can provide more detailed information about a smaller set of the music. This can produce an effect similar to “zooming into” a portion of the graphical representation. To provide more detailed information about a particular song, for example, the electronic device can represent the song using attributes that are more and more specific to the song as the level of detail increases. For example, initially the electronic device can group and represent songs by their genre in a first level of detail, then by their artist in a second level of detail, and then by their album in a third level of detail.

The graphical representation can be presented at a first level of detail in response to a user request to view information about music. From the first level of detail, the user can request displays of second and subsequent levels of detail. This way, a user can locate music of interest by narrowing the set of music elements being displayed at each level and may, for example, create a playlist using the located music or instruct electronic device 100 to begin playing the located music. The user can request the graphical representation using any suitable approach. For example, input interface 112 can include a dedicated button, and responsive to user initiation of the dedicated button, electronic device 100 can provide the graphical representation at the first level of detail. Alternatively, electronic device 100 can provide a music main menu or a home screen from which the user can initiate display of the graphical representation. In some embodiments, the user can request that electronic device 100 initially display the music at a second or subsequent level of detail. For example, the user can initially define a set of music elements using a textual list-based menu (instead of using a graphical representation at a first level of detail), and can then request that the set of music elements be displayed at the second level of detail.

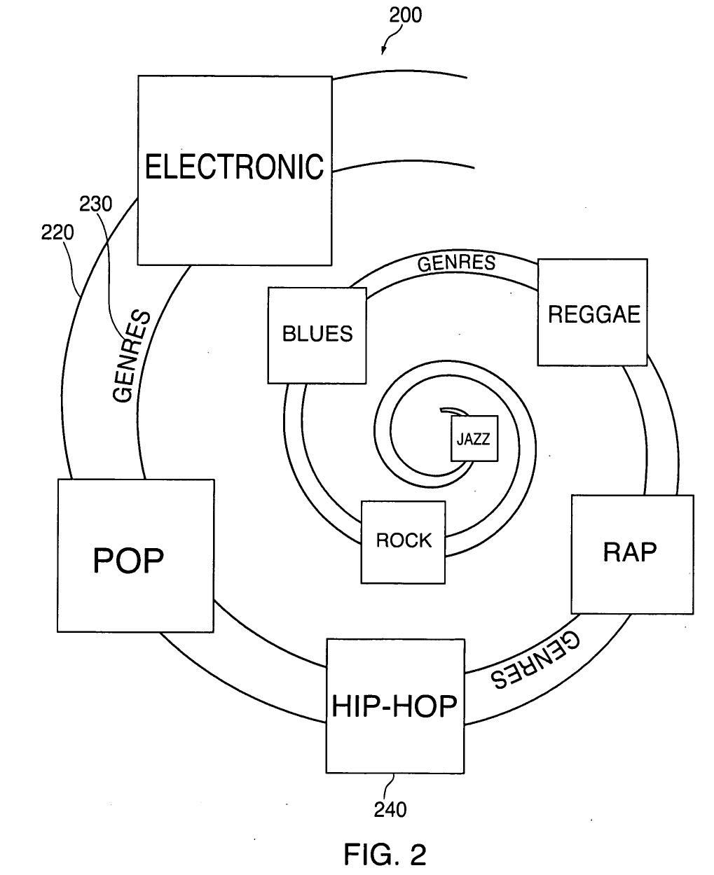

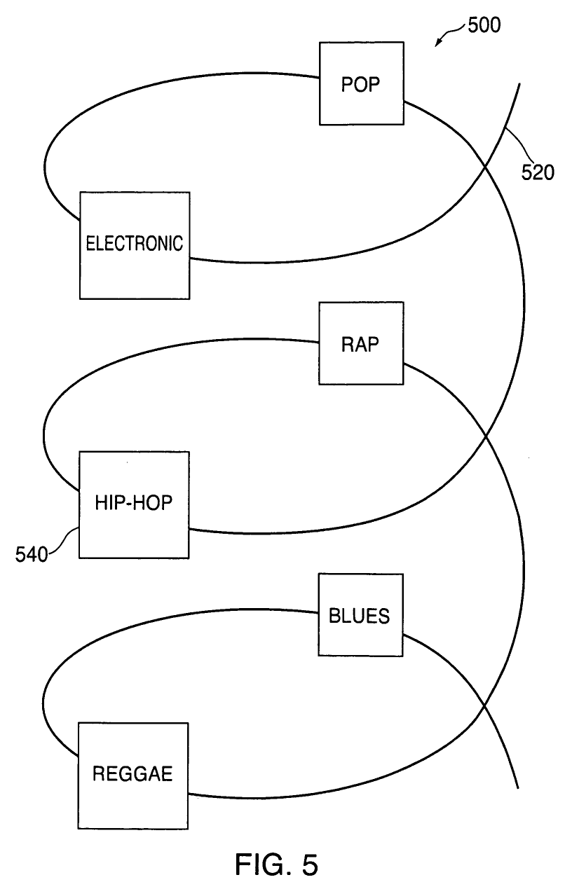

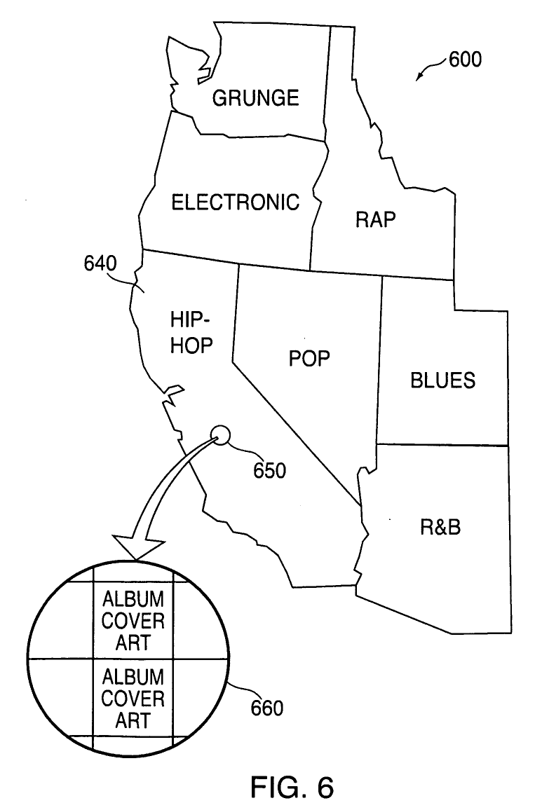

Electronic device 100 can provide a graphical representation of music in any suitable form. In some embodiments, and as shown in FIGS. 2-4, the electronic device can provide a spiral-based graphical representation (or “spiral representation”). In other embodiments, and as shown in FIG. 5, the electronic device can provide a helix-based graphical representation (or “helical representation”). In still other embodiments, and as shown in FIG. 6, the electronic device can provide a map-based graphical representation (or “map representation”). FIGS. 2-6 will therefore be described with continued reference to electronic device 100 and its components.

However, it should be understood that these figures are merely illustrative, and that graphical representations based on other two-dimensional or three-dimensional shapes or curves (e.g., line(s), wave(s), zigzag(s), a plane, or a grid), which can be angled in any direction on the display screen and have any suitable depth, may be used without departing from the scope of the invention. In some embodiments, the graphical representation may present the music elements in a scattered format in which a particular shape may not be defined or is loosely defined. Moreover, while some features may be described with reference to one type of graphical representation described below (e.g., spiral, helical, or map), it should be understood that these features can be adapted for use in other types of graphical representations.

Referring first to FIG. 2, illustrative spiral representation 200 is shown, which may be presented by display 116 (FIG. 1) of electronic device 100. Electronic device 100 can provide spiral representation 200 in response to a user request to view information about music, such as the music stored on storage 106 (FIG. 1). Spiral representation 200 can include spiral 220. As shown in FIG. 2, spiral 220 can include a curve that circles around a central point and appears to move closer to the user as the curve circles away from the central point. Electronic device 100 can display graphics (including graphic 240) along spiral 220. The graphics displayed at a greater radius from the central point may be larger than those closer to the central point to further provide the illusion of depth.

The graphics displayed along spiral 220 can represent the music at a first level of detail. The first level of detail can be associated with one attribute type (e.g., genre), and each of the graphics can represent the music associated with a particular attribute of that attribute type. Graphic 240, for example, can represent some or all of the hip-hop music stored on storage 106. The graphics of the genres can be displayed in any suitable order. In some embodiments, the genres can be displayed in alphabetical order. In other embodiments, electronic device 100 can display related or similar genres next to each other. For example, since many songs can be classified as both rock and pop, electronic device 100 may display these genres next to one another.

Each graphic displayed along spiral 220 can include pictures, graphics, text, or a combination thereof, and can take on any suitable shape (e.g., a square, rectangle, ball, circle, triangle, or diamond). For example, each graphic can include album cover art representative of a particular genre. In other embodiments, electronic device 100 may not provide separate graphics, and may instead associate different sections or regions of spiral 220 with different genres. Spiral 220 can visually distinguish between the different graphics or the different sections using, for example, different colors, sizes/widths, markers, or using any other suitable approach. In some embodiments, spiral 220 can include transitional sections between different sections of spiral 220, such as color gradients to fade between the different colors.

In some embodiments, electronic device 100 can display information about spiral representation 200 along spiral 220 as textual information 230. For example, because spiral representation 200 organizes the music based on the genre attribute type, electronic device 100 can display “GENRES” as textual information 230. In other embodiments, electronic device 100 can provide textual information 230 at some location separate from spiral 220.

A user of electronic device 100 can change which genres of music are provided along spiral 220. In some embodiments, electronic device 100 can receive a clockwise or counterclockwise input from input interface 112, such as from a circular or elliptical motion received on a click wheel or on a touch screen, to change the presented music. Responsive to a clockwise input, the graphics can rotate in a clockwise direction along spiral 220 and can gradually increase in size. For example, as graphic 240 moves, graphic 240 can rotate into the position of the pop music graphic in FIG. 2, then into the position of the electronic music graphic in FIG. 2, and finally “disappear” from spiral representation 200. Also, additional graphics for music in other genres can rotate into view from the center of spiral 220 as a clockwise input is received. This movement can produce the effect of spiral 220 rotating and traveling towards the user, such that the closest genres eventually move behind the user (and out of view) while the genres further down the spiral come into view.

A counterclockwise input can provide a similar effect as a clockwise input. Responsive to a counterclockwise input, the genre graphics can rotate down spiral 220, and additional genre graphics can appear from the outermost edge of spiral 220. This can produce the effect of spiral 220 rotating and traveling down and away from the user, such that genres originally “behind” the user come into view and genres further down spiral 220 become too far away to see. Thus, by rotating spiral in a clockwise or counterclockwise direction, the user can view all of the available music (e.g., stored in storage 106) at the first level of detail.

The user can request a display of more detailed information about the music. Once the user determines which genre or genres of music are of interest, the user can request that more detailed information about the music in that genre or those genres be displayed. Electronic device 100 can interpret any suitable type of input as a request to view additional information. In some embodiments, input interface 112 can include a multi-touch touch screen, and electronic device 100 can interpret a “pinch-in” motion (where two inputs on the touch screen are moved away from each other) as a request to view more detailed information. Responsive to such an input, electronic device 100 can provide a graphical representation of the music using a second level of detail.

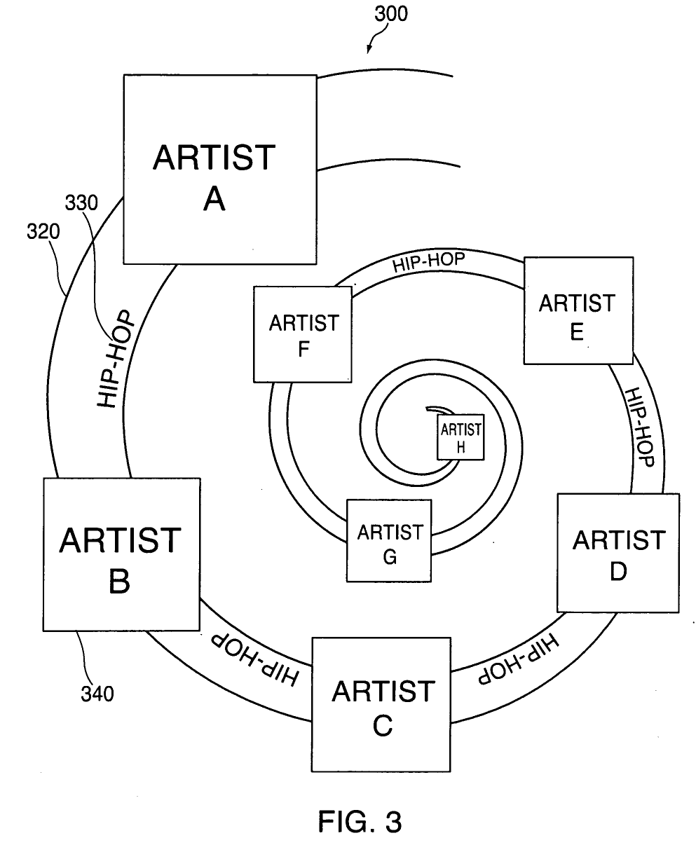

FIG. 3 is a spiral representation of the music which can be displayed by electronic device 100 responsive to a user request to view the music at a second level of detail. Spiral representation 300, which can include multiple graphics provided along spiral 320, can have any of the features of spiral representation 200 (FIG. 2) and vice versa. Here, each graphic (including graphic 340) can be associated with particular artists. For example, graphic 340 may represent the music (e.g., songs) released by Artist B. Since multiple artists can release music in the same genre, representing the music by artist (as in FIG. 3) may be more a specific, and therefore more a detailed, way to represent the music than by genre (as in FIG. 2).

Electronic device 100 can initially provide spiral representation 300 responsive to a user input to view more detailed information about the hip-hop genre. For example, electronic device 100 can provide spiral representation 300 in response to receiving a “pinch in” input over the display of hip-hop graphic 240 (FIG. 2). Because this can provide the effect of zooming into hip-hop graphic 240, it can appear as if a closer view of graphic 240 reveals that graphic 240 is actually made up of a cluster of graphics associated with hip-hop artists. To enhance this effect in embodiments where graphic 240 is distinguished from other graphics of FIG. 2 by color, spiral 320 can have a color that corresponds to the color of graphic 240. The user can return from spiral representation 300 to spiral representation 200 (FIG. 2) using a “pinch out” motion (where two inputs on the touch screen are moved towards each other).

In some embodiments, electronic device 100 can provide, as textual information 330, information on one or more attributes associated with the graphical representations of any of the previous levels of detail. For example, textual information 330 can include “HIP HOP” to indicate that the artists displayed along spiral 220 are associated with the hip-hop genre and that spiral representation 300 may be a zoomed-in view of hip-hop graphic 240 (FIG. 2). Electronic device 100 can display any other suitable information in addition to or instead of attributes, such as “Artists” to indicate that spiral representation 300 is organized based on artist.

Responsive to a clockwise or counterclockwise user input, electronic device 100 can provide additional graphics that represent the music for other hip-hop artists (if available). In some embodiments, electronic device 100 can limit the display to music satisfying the attributes previously selected by the user. For example, if the user zoomed into the hip-hop genre at a first level of detail (e.g., from spiral representation 200 of FIG. 2), the music displayed at the second level of detail might include only hip-hop artists.

In other embodiments, once music in the hip-hop genre has been presented, electronic device 100 can begin displaying music in the other genres that were not selected. For example, referring also to FIG. 2, because hip-hop graphic 240 is adjacent to the rap genre and pop genre graphics, a clockwise input can cause electronic device 100 to eventually display music in the rap genre at the second level of detail, while a counterclockwise input can cause electronic device 100 to eventually display music in the pop genre at the second level of detail. This way, the representation of the music in FIG. 3 can appear to be a more detailed view of the representation in FIG. 2, where the initial selection of hip-hop graphic 240 defines the location to zoom into but does not limit the displayed music.

The hip-hop artists can be displayed as graphics in any suitable order. In some embodiments, the artists can be displayed in alphabetical order by first name, last name, or band name. In other embodiments, because the hip-hop genre is displayed between the pop and rap genres in FIG. 2, electronic device 100 can distribute the hip-hop artists along spiral 320 based on each artist's association with the pop and rap genres. For example, as the user moves down spiral 320, hip-hop artists that also release pop songs or songs with pop-like qualities can be displayed first, then hip-hop artists that do no produce pop or rap-like songs, and finally hip-hop artists that also produce rap songs or songs with rap-like qualities. This way, as the user moves spiral 320 through pop, hip-hop, and then rap songs, the music represented along spiral 320 can gradually progress between these three genres.

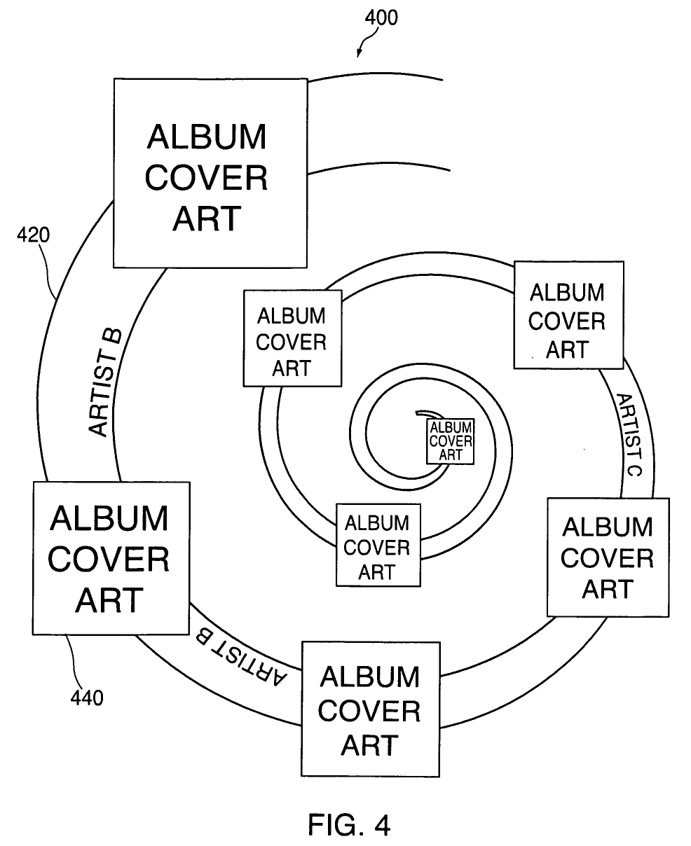

Turning to FIG. 4, spiral representation 400 is shown which may present the music at a third level of detail. In some embodiments, electronic device 100 can display spiral representation 400 in response to a user input from spiral representation 300 (FIG. 3) to view more information about Artist B. Spiral representation 400, which includes multiple graphics (including graphic 440) along spiral 420, can have any of the features described above in connection with spiral representations 200 (FIG. 2) or 300, and vice versa. At the third level of detail, each graphic (including graphic 440) can represent the music from a particular album. Since each artist can release multiple albums, representing music (e.g., songs) by album may be more specific, and therefore more detailed, information about the music. In some embodiments, the graphic can include cover art for the associated album.

In some embodiments, spiral representation 400 corresponding to the third level of detail may be the last level of detail. In these embodiments, electronic device 100 can perform any suitable functions responsive to a user selection of one of the graphics. For example, electronic device 100 can play the songs from the selected album, create a playlist based on the selected album, or display a textual menu including songs from the selected album. In other embodiments, spiral representation 400 can be an intermediate level, and electronic device 100 can continue to receive user requests to view more detailed information about the music (e.g., by song name).

FIGS. 2-4 provide an example of a graphical menu that displays music in three levels of detail, where the three levels are associated with the genre, artist, and album attributes, respectively. It should be understood that, for FIGS. 2-4 as well as for the remaining figures, other attributes can be used instead of those illustrated, fewer or more levels of detail can be provided, and each level of detail can be associated with more than one attribute.

Turning now to FIG. 5, a helix-based graphical representation of music is shown. Helical representation 500 can include helix 520, which can coil from one edge (e.g., the top edge) of a display screen to the opposite edge (e.g., the bottom edge) of the display screen. Helical representation 500 can include multiple graphics (including graphic 540) displayed along helix 520. Helical representation 500 can include any of the features of the spiral-shaped graphical representations discussed above in connection with FIGS. 2-4, and vice versa. For example, the graphics can be associated with different genres and may represent the music in a first level of detail.

In some embodiments, the user can view graphics for music in other genres using a clockwise or counterclockwise input. This can cause electronic device 100 to rotate the graphics such that the graphics move up or down helix 520. In other embodiments, the user can view additional graphics by providing, for example, an upward or downward flicking motion on a multi-touch touch screen (or any other upward or downward input). Responsive to the upward or downward input, electronic device 100 can move helix 520 up or down, revealing more of helix 520 (and therefore graphics) at one of its ends.

From helical representation 500, electronic device 100 can receive a user input to view more detailed information about the music. Responsive to this user input, electronic device 100 can provide a second helical representation similar to helical representation 500, where the second helical graphical representation represents music using a more specific attribute (e.g., by artist or by album, or a combination thereof).

FIG. 6 is graphical map-based representation of music, which can be another type of graphical representation electronic device 100 can provide in additional to or instead of a spiral or helical representation. Map 600 can include various regions, such as region 620. Map 600 (and its regions) can have any of the features of the spiral or helical representations (with their graphics) described above in connection with FIGS. 2-5, and vice versa.

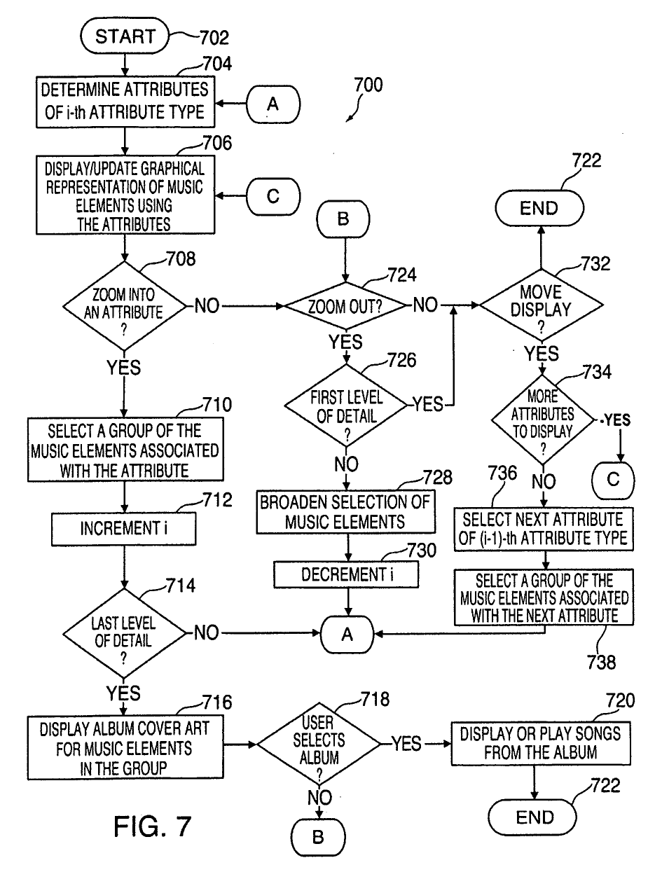

In some embodiments, map 600 can, at the first level of detail (or at any subsequent level of detail), correspond to a real-life geographic location. In these embodiments, map 600 can be organized into real-life geographic regions (e.g., based on real-life boundaries between states or other distinct geographic regions). In FIG. 7, for example, map 600 can correspond to the United States, and region 640 can have the general shape and relative location of the state of California. In other embodiments, map 600 can correspond to another geographic location that is divided into multiple regions (e.g., another country having multiple states or provinces, a state having multiple counties, or a county having multiple cities). In still other embodiments, map 600 can be a fictitious location or landmass with fictitious regions.

In some embodiments, the regions in map 600 may be associated with different attributes of a particular attribute type. For example, in FIG. 6, the regions can be associated with different genres and region 640 can represent music in the hip-hop genre. Electronic device 100 can receive user requests to view more detailed information about the music (e.g., from a “pinch in” motion on a multi-touch touch screen). Responsive to an input directed at a particular location on map 600, electronic device 100 can provide a more granular representation of the music at that particular location. This can cause electronic device 100 to provide a display corresponding to, for example, a county-view or city-view of that particular location. The county or city-view may have regions with real-life or fictitious county/city boundaries, where the regions at this next level of detail can be associated with different artists, for example.

At the last or intermediate level of detail, electronic device 100 can display cover art associated with the music. In some embodiments, the cover art may be organized into a grid or into any other suitable structure. For example, responsive to one or more user inputs to zoom into location 650, electronic device 100 can provide a display that includes portion 660, where portion 660 can include a grid of cover art for albums in the hip-hop genre. Electronic device 100 can eventually provide a grid that includes cover art for pop albums responsive to one or more user requests to move the display in an “easterly” direction (e.g., using a flicking motion on a touch screen). This way, map 600 can appear as if it is composed of a grid of cover art, but where the individual cover art is viewable only at granular displays of map 600. In some embodiments, the size of the album cover art in each region can depend on the number of albums in each genre. Alternatively, electronic device 100 can display placeholders or the same cover art multiple times if there is not enough albums to fill the grid.

In some embodiments, electronic device 100 can distribute the cover art across a region in map 600 based on each album's similarity or compatibility with neighboring regions. Electronic device 100 can determine whether each hip-hop album includes songs from a neighboring region's genre or includes hip-hop songs that have qualities of the genre, and electronic device 100 can use this information to distribute the hip-hop albums across region 640. For example, cover art for hip-hop albums with electronic songs or songs having more electronic qualities can be located closer to the northern border of region 640, and cover art for hip-hop albums with pop songs or songs having more pop qualities can be located closer to the western border of region 640. Electronic device 100 can position cover art for albums that are not particularly compatible or similar to neighboring regions' genres in the center of the region. Thus, a user can zoom into a particular location within a region (e.g., close to the center of the region or towards one of the borders) to view information on albums having qualities currently desired by the user. In some embodiments, the albums or songs in a genre can be distributed in two or more different regions (e.g., Montana could also be associated with hip-hop) so that different border combinations are available.

In some embodiments, music can be distributed across map 600 based on the real-life locations of map 600. For example, rather than arbitrarily associating each genre to a state, electronic device 100 can associate each genre with a state in map 600 that has some significance to the genre. Electronic device 100 can associate a genre with a particular state using any suitable approach, such as based on where the genre originated from, where the genre is most popular, where a famous event occurred that was associated with the genre, or the hometown of a famous artist or producer of the genre. For example, grunge music can be associated with Washington state, since this genre originated in Seattle, Wash. Electronic device 100 can associate the attributes of any other attribute type (e.g., artist) in the same or a similar manner for graphical representations at other levels of detail.

In some embodiments, the attribute type associated with map 600 at a first (or subsequent) level of detail can be location-based, and the attribute associated with each state can include the state itself. For example, California region 640 can represent music released by artists whose hometown is in California or who currently reside in California. Alternatively, California region 640 can represent live recordings of music from concerts held in California. In these embodiments, the regions in map 600 can be labeled by their corresponding state names, and map 600, viewed at the first level of detail, may be similar to a real-life map. This way, a user who wants to determine which albums or songs from their music collection are from or related to a particular state can “zoom in” to that particular state.

FIG. 7 is an illustrative process 700 for providing displays of music elements of varying levels of detail. The steps of process 700 can be executed by an electronic device, such as electronic device 100 of FIG. 1 to produce graphical representations of music similar to the graphical representations of FIGS. 2-5, or to produce graphical representations based on different shapes or structures. The music elements represented by the graphical representations can include songs or albums stored on the electronic device (e.g., storage 106) or on a server accessible by the electronic device. In some embodiments, the steps of process 700 can represent machine-readable instructions recorded on machine-readable media (e.g., computer-readable media, such as an electrical, mechanical, or optical storage media).

Process 700 can begin at step 702. At step 704, the electronic device can determine the attributes of a first attribute type for the music elements. The first attribute type can be any suitable type (e.g., genre, artist, album, release date, date of purchase or download, or song speed) that enables the electronic device to categorize the music into music groups, and each of the music elements can be associated with one or more attributes of the first attribute type. In some embodiments, step 704 can involve determining the genre(s) associated with each music element and categorizing the music into music groups based on their respective genres.

Process 700 can then continue to step 706. At step 706, the electronic device can display a graphical representation of the music elements using the attributes of the first attribute type. For example, the graphical representation can include a spiral, helix, or map that includes graphics or regions each associated with one of the attributes of the first attribute type. This way, the electronic device can provide a representation of the music at a first level of detail. In some embodiments, the electronic device may display only a portion of the attributes if, for example, the space in graphical representation is limited.

Then, at step 708, the electronic device can determine whether a user request has been received to “zoom into” or view more detailed information about the music elements of one of the attributes. For example, the electronic device can determine whether a “pinch in” user input has been received on a multi-touch touch screen (e.g., included in input interface 112). If, at step 708, the electronic device determines the user has “zoomed into” one of the attributes, the electronic device can select a group of the music elements at step 710. The group selected can include the music elements associated with the selected attribute (e.g., the songs or albums in a particular genre). Process 700 may then continue to step 712, which enables the electronic device to provide a graphical representation of the music at the second level of detail at step 716 or 706.

If, at step 714, the electronic device determines that the second level of detail is the last, finest level of detail, the electronic device can display album cover art (e.g., a grid of album cover art) for the selected music elements at step 716. This way, the user is provided with album information for the selected music elements. Then, the electronic device can determine whether the user has selected one of the displayed album covers at step 718. If not, process 700 can move to step 724, described below. If so, the electronic device can perform any suitable action based on the selected album at step 720. For example, the electronic device can play a song from the selected album or can provide a menu listing the songs available from the selected album. In other embodiments, the electronic device can form a playlist based on the songs in the album. Process 700 can then end at step 722.

Returning to step 714, if the electronic device instead determines that the second level is not the last level of detail, process 700 can return to step 704. At step 704, the electronic device can determine, for the group of music elements corresponding to the “zoomed in” attribute, the attributes of a second attribute type. For example, if the user previously requested more detailed information about the music elements in the hip-hop genre, the electronic device can determine the artists of the hip-hop music. Then, at step 706, the electronic device can update or revise the graphical representation of the music using some or all of the attributes of the second attribute type (depending on available space in the graphical representation). This way, the electronic device is able to provide more detailed information about some of the music (e.g., hip-hop music) than that provided at the first level of detail. The electronic device can continue to display increasing levels of detail for smaller and smaller groups of the music elements in this manner until the last level of detail is reached.

In some scenarios, the number of hip-hop artists, for example, may not be sufficient to generate a complete graphical representation at the second level of detail (e.g., to fill the graphics of the spiral graphical representation of FIG. 3). In some embodiments, at step 706, the electronic device can provide an incomplete graphical representation when this occurs (e.g., provide the spiral graphical representation of FIG. 3, but where graphics are not displayed along the entire spiral). Alternatively, additional steps can be added to process 700, and the electronic device can update the graphical representation with information on a non-selected or non-zoomed-into group of music. For example, the electronic device can determine the artists associated with the pop genre for use in completing the graphical representation.

Returning to step 708, if the electronic device determines that a user input to “zoom into” one of the attributes of a first or subsequent attribute type has not been received (or if the user does not select an album cover at step 718), process 700 can move to step 724. At step 724, the electronic device can determine whether a user input to “zoom out” of the graphical representation has been received. For example, the electronic device can determine whether a “pinch out” motion on a multi-touch touch screen has been received. If so, the electronic device can broaden the selection of music elements at step 728 if the current graphical representation is not already at its lowest level of detail. For example, if at step 726, the electronic device determines that the graphical representation is at a second (or subsequent) level of detail in which hip-hop artists are represented, the electronic device can return from selecting only hip-hop music to selecting music elements from multiple genres. This way, the electronic device can display information for more of the music elements with less detail.

Process 700 can continue to step 730, which enables the electronic to provide a display at a lower level of detail. More particularly, process 700 can return to steps 704 and 706, so that the electronic device can update the graphical representation using attributes at a lower level of detail.

Returning to step 724, if the electronic device determines that a user request to zoom out of the graphical representation has not been received, process 700 can move to step 732. At step 732, the electronic device can determine whether a user request to move the displayed graphical representation has been received. For example, the electronic device can determine whether a flicking motion in any direction has been received on a touch screen. If not, process 700 can end at step 722. Alternatively, process 700 can move back to step 708 to determine whether a user input to zoom into an attribute has been received.

If, at step 732, the electronic device determines that a user request to move the displayed graphical representation has been received, process 700 can continue to step 734. At step 734, the electronic device can determine whether there are additional attributes of the current attribute type have not been displayed in the graphical representation. For example, the electronic device can determine whether additional hip-hop artists have not yet been displayed due to space limitations of the graphical representation. If there are additional attributes to be displayed, the electronic device can update the graphical representation at step 706 to include the additional attributes. Otherwise, the electronic device may need to display information about a non-selected group of music (e.g., pop music) to complete the graphical representation, and therefore process 700 can move to step 736.

At step 736, the electronic device can select one or more attributes of a previous attribute type that was not previously “zoomed into,” if one is available, and can select the music elements of this previous attribute type at step 738. In some embodiments, the electronic device can select the music elements for the next or neighboring attribute from the previous graphical representation. For example, if the user previously zoomed into the hip-hop genre from spiral representation 200 of FIG. 2 to view hip-hop artists in the current spiral representation, the electronic device can select the pop genre after all of the hip-hop artists have been displayed. Process 700 can then return to step 704 to, for example, determine the artists associated with the pop genre, and to update the graphical representation to include pop artists at step 706. In particular, at step 706, the electronic device can update the graphical representation to include a combination of hip-hop artists and pop artists, or just pop artists.

It should be understood that process 700 is merely illustrative. Any steps in process 700 can be modified, removed, combined, and any steps may be added, without departing from the scope of the invention.

The described embodiments of the invention are presented for the purpose of illustration and not of limitation, and the invention is only limited by the claims which follow.

What is claimed is:

1. A method of providing a plurality of music elements to a user of an electronic device, the method comprising:
determining a first plurality of attributes of a first attribute type associated with the music elements;
displaying a first graphical representation of the music elements using the first plurality of attributes;
receiving a user request to view more detailed information about the music elements associated with at least one of the first plurality of attributes;
determining a second plurality of attributes of a second attribute type for the music elements associated with the at least one of the first plurality of attributes; and
displaying a second graphical representation using at least a portion of the second plurality of attributes, wherein the second graphical representation comprises a plurality of album cover art.

2. The method of claim 1, wherein determining the first or second plurality of attributes comprises:
identifying a plurality of different genres, artists, release dates, dates of purchase or acquisition, or beats per minute each associated with at least one of the music elements.

3. The method of claim 1, wherein displaying the graphical representation comprises:
presenting a plurality of regions on a display screen, each of the regions representing the music elements associated with one of the plurality of attributes.

4. The method of claim 1, the method further comprising:
detecting whether the user-requested music elements are associated with other attributes of the first attribute type; and
distributing the second plurality of attributes in the second graphical representation based on the detecting.

5. The method of claim 1, the method further comprising:
determining an initial plurality of attributes of an initial attribute type associated with the music elements;
displaying an initial graphical representation using the initial plurality of attributes; and
receiving an initial user request to view more detailed information about at least one of the initial plurality of attributes, wherein the first plurality of attributes are determined responsive to receiving the initial user request.

6. The method of claim 1, the method further comprising:
receiving a user selection of one of the plurality of album cover art; and
performing an action based on an album associated with the selected album cover art, wherein performing the action comprises at least one of: playing a song from the album, creating a playlist using songs from the album, and providing a menu with the songs from the album.

7. The method of claim 1, the method further comprising:
receiving a user instruction to move the graphical representation;
determining a third plurality of attributes of the second attribute type, wherein the third plurality of attributes are associated with another one of the first plurality of attributes; and
revising the graphical representation to include at least a portion of the third plurality of attributes.

8. An electronic device for providing a plurality of music elements to a user, the music elements each associated with a first attribute and a second attribute, wherein the electronic device comprises a display, a user input interface, and control circuitry configured to:
direct the display to provide a graphical representation of the music elements, wherein the graphical representation comprises a curve, and wherein the music elements are represented along the curve using the first attributes of the music elements;
receive, from the user input interface, a user request to view more detailed information about a portion of the music elements; and
direct the display to revise the graphical representation, wherein the revised graphical representation represents the portion of the music elements along the curve using the second attributes of the music elements.

9. The electronic device of claim 8, wherein the curve comprises a spiral.

10. The electronic device of claim 8, wherein the curve comprises a helix.

11. The electronic device of claim 8, wherein the control circuitry is further configured to:
receive, from the touch screen, a user input directed in a particular direction; and
update the graphical representation to represent additional music elements along one end of the curve based on the particular direction.

12. The electronic device of claim 8, wherein the graphical representation comprises a first plurality of graphics displayed along the curve, each of the graphics associated with one of the first attributes.

13. The electronic device of claim 8, wherein the revised graphical representation comprises a second plurality of graphics displayed along the curve in place of the first plurality of graphics, and wherein the second plurality of graphics are each associated with one of the second attributes.

14. The electronic device of claim 8, wherein the user input interface comprises a multi-touch touch screen, and wherein the control circuitry is further configured to:
receive, as the user request to view more detailed information, a multi-touch input from the multi-touch touch screen over an area of the graphical representation; and
direct the display to revise the graphical representation based on the area of the multi-touch input.

15. An electronic device for presenting a plurality of music elements to a user, the electronic device comprising a display, a user input interface, and control circuitry configured to:
determine a plurality of attributes of a particular attribute type associated with the music elements;
direct the display to present a map, the map comprising a plurality of regions corresponding to real-life geographic areas, wherein each of the regions represents the music elements associated with one of the plurality of attributes;
receive, from the user input interface, a user selection of one of the regions;
direct the display to present a graphical representation of a portion of the music elements associated with the selected region.

16. The electronic device of claim 15, wherein the graphic representation represents the portion of the music elements using attributes of a different attribute type.

17. The electronic device of claim 15, wherein the graphical representation comprises a grid of album cover art.

18. The electronic device of claim 17, wherein the selected region borders at least another one of the regions, and wherein the control circuitry is further configured to:
determine whether the music elements associated with the selected region are also related to the attribute associated with the other region; and
distribute the album cover art in the grid based on the determination.

19. The electronic device of claim 15, wherein the real-life geographic area corresponding to each region is related to the one of the attributes of that region.

20. The electronic device of claim 17, wherein each of the attributes is related to a real-life geographic area based on at least one of: the attribute originated in the area, famous events relating the attribute occurred in the area, or a famous artist relating to the attribute lives or performs in the area.

21. The electronic device of claim 15, wherein each of the regions represents music elements associated with the corresponding real-life geographic area.

22. The electronic device of claim 21, wherein music elements are associated with a real-life geographic area based on one of: an artist of the music elements lives or lived in the geographic area, the music element was recorded in the real-life geographic area, or the music element is from a concert taking place in the real-life geographic area.

23. Machine-readable media for providing a plurality of music elements to a user of an electronic device, the machine-readable media comprising machine-readable instructions recorded thereon for:
determining a first plurality of attributes of a first attribute type associated with the music elements;
displaying a first graphical representation of the music elements using the first plurality of attributes;
receiving a first user request to view more detailed information about the music elements associated with at least one of the first plurality of attributes;
determining a second plurality of attributes of a second attribute type for the music elements associated with the at least one of the first plurality of attributes; and
displaying a second graphical representation using at least a portion of the second plurality of attributes, wherein the second graphical representation comprises a plurality of album cover art.

24. The machine-readable media of claim 22, wherein the first or second attribute type comprises at least one of: genre, artist, release date, date of purchase or acquisition, and song speed.

25. The machine-readable media of claim 22, the machine-readable media further comprising machine-readable instructions recorded thereon for:
receiving a user selection of one of the plurality of album cover art; and
performing an action based on an album associated with the selected album cover art, wherein performing the action comprises at least one of: playing a song from the album, creating a playlist using songs from the album, and providing a menu with the songs from the album.
